(19) United States
(12) Patent Application Publication
(10) Pub. No.: US 2015/0066356 A1
(43) Pub. Date: Mar. 5, 2015

(54) NAVIGATION SEARCH AREA REFINEMENT

(71) Applicants: David M. Kirsch, Torrance, CA (US); Cesar Cabral, Los Angeles, CA (US)

(72) Inventors: David M. Kirsch, Torrance, CA (US); Cesar Cabral, Los Angeles, CA (US)

(73) Assignee: Honda Motor Co., Ltd., Tokyo (JP)

(21) Appl. No.: 14/018,108

(22) Filed: Sep. 4, 2013

(51) Int. Cl. G01C 21/36

(52) U.S. Cl. CPC G01C 21/3664
USPC 701/425; 701/538; 701/533; 701/408

(57) ABSTRACT

Systems and methods for providing navigation information based on a user request and a user-refined search area are discussed. One such system for navigation search area refinement provides an efficient system and method for refining a navigation information search area based on a default search area and an intuitive gesture input marking an area of a map display. Additionally, a method for navigation search area refinement can include receiving a gesture input originating at a default search area and concluding at a user-refined search area.

The disclosure relates generally to the field of user interfaces for vehicle navigation systems and devices. Specifically, the disclosure relates to a user interface for a system that provides point of interest information within a user-refined search area. The system may also include numerous additional features such as for example those discussed in greater detail below in regards to the example figures.

### BACKGROUND

Navigation and route guidance systems generally provide map and routing data, point-of-interest (POI) information and local driving conditions based on a present location. While such systems offer a variety of features, many times the features aren't easily accessible and are presented in a very non-intuitive manner. For instance, most systems provide information based on a current location and do not provide a user friendly interface for customizing a search area so that information for a chosen geographic area is displayed. Requiring the user to provide exacting details about a search area can be time consuming and demands too much attention. This is particularly significant for vehicle systems due to safety concerns.

### SUMMARY

The following presents a simplified summary of the disclosure in order to provide a basic understanding of certain aspects of the disclosure. This summary is not an extensive overview of the disclosure. It is not intended to identify key/critical elements of the disclosure or to delineate the scope of the disclosure. Its sole purpose is to present certain concepts of the disclosure in a simplified form as a prelude to the more detailed description that is presented later.

The disclosure disclosed and claimed herein, in one aspect thereof, includes systems and methods that facilitate refinement of a default search area for vehicle navigation systems. One such system and method can include a map display including a default search area and a gesture input component for touchscreen display for displaying a map and including a default search area. A user can define or refine a search area by gesturing or pointing in the direction the search is directed.

In another aspect, the disclosure can include a computer implemented method for providing navigation information based on a user-refined search area. One example method can include the acts of receiving a request for information, providing navigation information based on a default search area, receiving a gesture input originating at the default search area and providing relevant navigation information based on the user-refined search area.

In other aspects, the disclosure can include a first set of navigation information based on a first user input and a default search area; and a second set of navigation information including a user-refined search area, wherein the user-refined search area is based on a gesture input that commences at the default search area and concludes at the user-refined search area.

To the accomplishment of the foregoing and related ends, certain illustrative aspects of the disclosure are described herein in connection with the following description and the annexed drawings. These aspects are indicative, however, of but a few of the various ways in which the principles of the disclosure can be employed and the disclosure is intended to include all such aspects and their equivalents. Other advantages and novel features of the disclosure will become apparent from the following detailed description of the disclosure when considered in conjunction with the drawings.

### BRIEF DESCRIPTION OF THE DRAWINGS

FIG. 1 illustrates a block diagram of a system for providing navigation information in accordance with aspects of the disclosure.

FIG. 2 illustrates a flow chart of operations for providing navigation information in accordance with an aspect of the disclosure.

FIG. 3 illustrates navigation information displays associated with a navigation system in accordance with aspects of the disclosure.

FIG. 4 illustrates navigation information displays associated with a navigation system in accordance with aspects of the disclosure.

FIG. 5 illustrates navigation information displays associated with a navigation system in accordance with aspects of the disclosure.

FIG. 6 illustrates navigation information displays associated with a navigation system in accordance with aspects of the disclosure.

FIG. 7 illustrates navigation information displays associated with a navigation system in accordance with aspects of the disclosure.

FIG. 8 illustrates navigation information displays associated with a navigation system in accordance with aspects of the disclosure.

FIG. 9 illustrates navigation information displays associated with a navigation system in accordance with aspects of the disclosure.

FIG. 10 illustrates navigation information displays associated with a navigation system in accordance with aspects of the disclosure.

FIG. 11 illustrates navigation information displays associated with a navigation system in accordance with aspects of the disclosure.

FIG. 12 illustrates navigation information displays associated with a navigation system in accordance with aspects of the disclosure.

FIG. 13 illustrates a computing environment where one or more of the provisions set forth herein can be implemented, according to certain embodiments.

### DETAILED DESCRIPTION

The disclosure is now described with reference to the drawings, wherein like reference numerals are used to refer to like elements throughout. In the following description, for purposes of explanation, numerous specific details are set forth in order to provide a thorough understanding of the disclosure. It may be evident, however, that the disclosure can be practiced without these specific details. In other instances, well-known structures and devices are shown in block diagram form in order to facilitate describing the disclosure.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The system of the disclosure provides an intuitive, easy tool for refining a search area so that navigation information can be obtained with a minimum of effort and distraction. Conventional navigation system POI searches are generally conducted taking into account the current location and trajectory of a vehicle other search options generally involve extensive manual input causing the user to type on a touchscreen, scroll within a menu and/or navigate multiple menu layers. Such conventional systems do not provide an uncomplicated, natural way for the user to designate an alternate search area. The present disclosure provides a safe and efficient system and method for refining a navigation information search area based on a default search area and intuitive gesture input.

Although traditional vehicle navigation systems provide information for POIs within a particular distance from a current location, a user may have an interest in another nearby geographic area. A user may choose to search for POIs in an area that is near their work place, school, or a friend's house. A user may want information about POIs that establish a convenient meeting place. For example, the user may know they would like to end up at a particular locale at a given time or may have plans to meet a friend. The system and method of the disclosure provide a user-friendly approach for defining or refining a search area to accomplish a search, e.g. POI search, in a specific, chosen locality or geographic area.

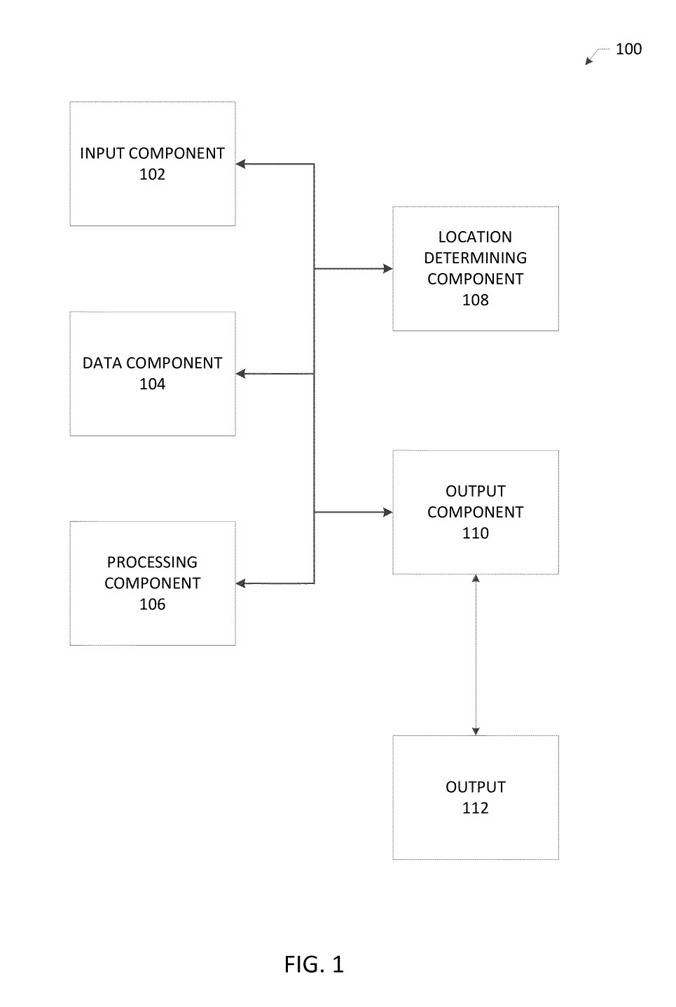

FIG. 1 illustrates an example block diagram of a navigation system 100 for providing navigation information based on a user input and for establishing a user-refined navigation or point of interest search area based on a default search area and a gesture input marking an area of a map display. System 100 includes input component 102, data component 104, processing component 106, location determining component 108, output component 110 and output 112.

Input component 102 can include one or more input devices such as keyboard, push button, mouse, pen, audio or voice input device, touchscreen or other touch input device, cameras, video input devices, gesture recognition module, or most any other input for receiving an input from a user. In an embodiment, the input component 102 includes a gesture recognition module for receiving a three-dimensional image, for example, image sensors such as stereo cameras, infrared cameras, depth cameras, charge-coupled devices, complementary metal oxide semiconductor active pixel sensors, infrared and/or thermal sensors, sensors associated with an image intensifier, and others.

Data component 104 can provide GPS information and/or database information to the processing component 106. In an embodiment, data component 104 can include information pertinent to a GPS location, map data, navigation information, and/or other information or points of interest.

Processing component 106 can receive input for processing from any of the input component 102, data component 104, location determining component 108, output component 110 and/or the output 112. Processing component 106 can include hardware and/or software capable of receiving and processing gesture input, for example, hardware and/or software capable of performing gesture recognition. Gesture input can include for example user input at a touchscreen display and three-dimensional gesture input. Processing component 106 can include hardware and/or software capable of receiving and processing voice input, for example, hardware and/or software capable of performing voice recognition and speech recognition

Processing component 106 can include hardware and/or software capable of receiving and processing navigation related input, for example, GPS location, map data, and point of interest data.

Location determining component 108 can include most any components for obtaining and providing navigation and location related information, including but not limited to, GPS antenna, GPS receiver for receiving signals from GPS satellites and detecting location, direction sensor for detecting the vehicle's direction, speed sensor for detecting travel distance, map database, point of interest database, other databases and database information and other associated hardware and software components.

Output component 110 is capable of receiving input from the processing component 106, and any of the input component 102, data component 104, location determining component 108, and can provide an audio, visual or other output 112 in response. For example, the output component 112 can provide an output, or outputs, 112 including route guidance, turn-by-turn directions, confirmation of a location or destination, point of interest list, point of interest indicators and map display. In other embodiments, the output component 110 can provide output 112 indicating sign information, shopping information, sightseeing information, advertising and any other information of interest. In an embodiment, output component 110 can provide an output 112 capable of being observed on, for example, a center console display, a heads-up display (HUD) within a vehicle, or meter display.

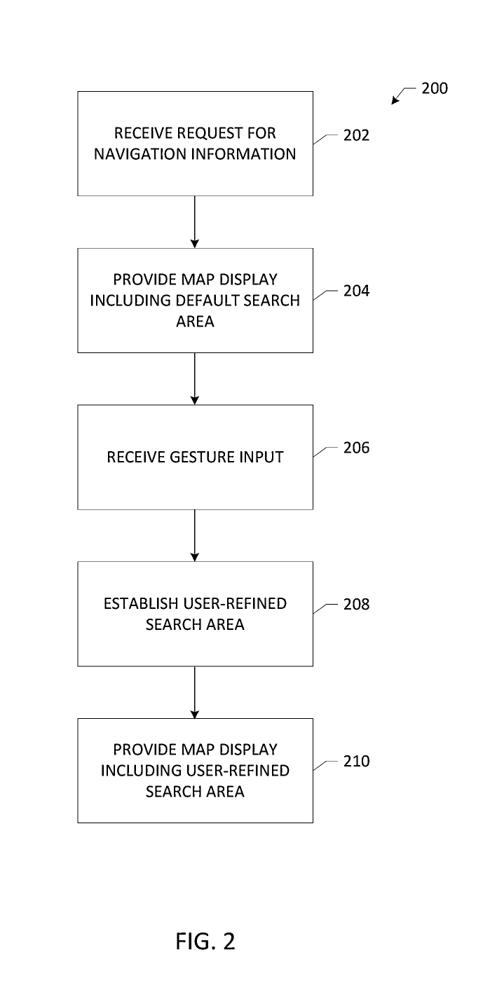

FIG. 2 illustrates a computer implemented method 200 of providing navigation information based on a user-refined search area in accordance with aspects of the disclosure. While, for purposes of simplicity of explanation, the one or more methodologies shown herein, e.g., in the form of a flow chart, are shown and described as a series of acts, it is to be understood and appreciated that the disclosure is not limited by the order of acts, as one or more acts may, in accordance with the disclosure, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosure.

Method 200 can begin at 202 by receiving a user initiated request for navigation information. For example, the system 100 receives a user request for point-of-interest (POI) information. At 204, the navigation system provides a first set of navigation information. In response to the user's request for POI information, the system displays a map including a current location and default search area indicators at a touchscreeen display. The system 100 can also display a POI listing including those POIs satisfying the user's request that are located within the default search area.

In aspects, the default search area indicator can include a generally circular area having a pre-determined radius surrounding the current location of the vehicle on a map display. The default search area indicates the generally circular geographical area within which the search was directed. For example, the default search area can include an area encompassing a 2 kilometer area around the vehicle or user. In response to a user request for a POI such as a coffee shop, the system 100 returns a list of coffee shops within the default search area and displays corresponding indicators on the map display.

At act 206, the system receives a gesture input from the user. The user may perform a gesture input, e.g. a tap and drag motion or gesture, at a touchcreeen display. In accordance with an embodiment, the user engages the default search radius by tapping a default search radius indicator circle on the touchscreen. The user can drag the indicator circle along the map in the chosen direction. In response to the gesture input, the default search, as indicated on the map display, can be extended or moved in a particular direction. The user can transform or morph the default search area to suit his particular needs for navigation information in a specific area using a gesture at the touchscreen display. For example, the user can engage the default search radius and drag a finger in a direction of interest to establish a user-refined search area.

At 208, in response to the user input, the system 100 establishes a refined search area. The user-refined search area can include the present location of the vehicle and can extend to the area indicated on the touchscreen display by the user. The current vehicle location can act as an anchor and a user-refined search area can be established that includes both the current vehicle location and a user defined point on the touchscreen. In an aspect, a gesture input for refining a default search area can originate at a point within a default search area and can conclude at a user defined point on a map display.

As noted, one advantage of the disclosure over conventional navigation systems is that a default search area can be easily and intuitively refined by the user so that a request for information is directed towards the geographical area of interest rather than solely on the vehicle's current location. For example, a touchscreen can provide for selection of a wide range of search areas that would otherwise be time-consuming and cumbersome to input to a traditional navigation system.

At 210, updated navigation information based on the user-refined search area is provided to the user. An updated map display, point of interest list and point of interest map indicators can be displayed. In an embodiment, the user can provide additional gesture input 206 to further refine and/or define a search area of interest.

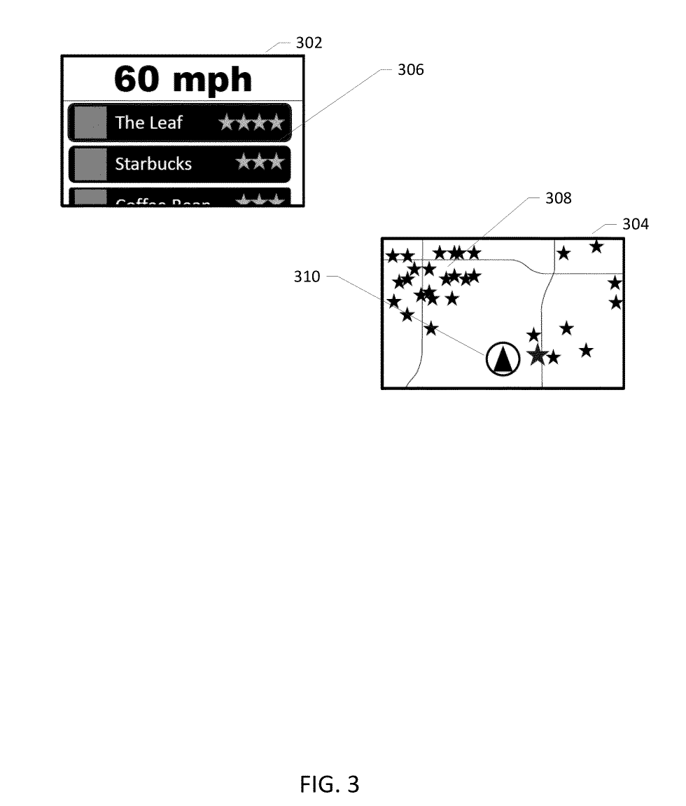

As shown in FIG. 3, a navigation system 100 includes a meter display 302 and a touchscreen display 304. The system 100 responds to a user request for POI information by displaying a list of pertinent POIs 306 at the meter display 302 and by rendering a map display at the touchscreen display 304. The map display can include POI location indicators 308 and current vehicle location indicator 310. In this example, the POI search criterion entered by the user is a request for “coffee shops”. The system can be configured to display a listing of POIs 306 that satisfy a search criteria input by the user. The POI list 306 and POI location indicators 308 represents POIs that satisfy the search criteria entered by the user and are located within the default search area. As shown, the system has responded to a user request for a specific type of POI, in other embodiments, the system can provide navigation information including responses to more general search requests.

In an aspect, the pre-determined search area is a substantially circular area with a radius of about 1-10 kilometers, having the current vehicle location at its center. In other aspects, a pre-determined or default search area can be smaller or larger and can include most any shape or form, for example, square, rectangular, triangular, hexagonal, octagonal, polygonal, U-shaped, T-shaped, trapezoidal, conical, or elliptical. The default search area can be asymmetrical or irregularly shaped.

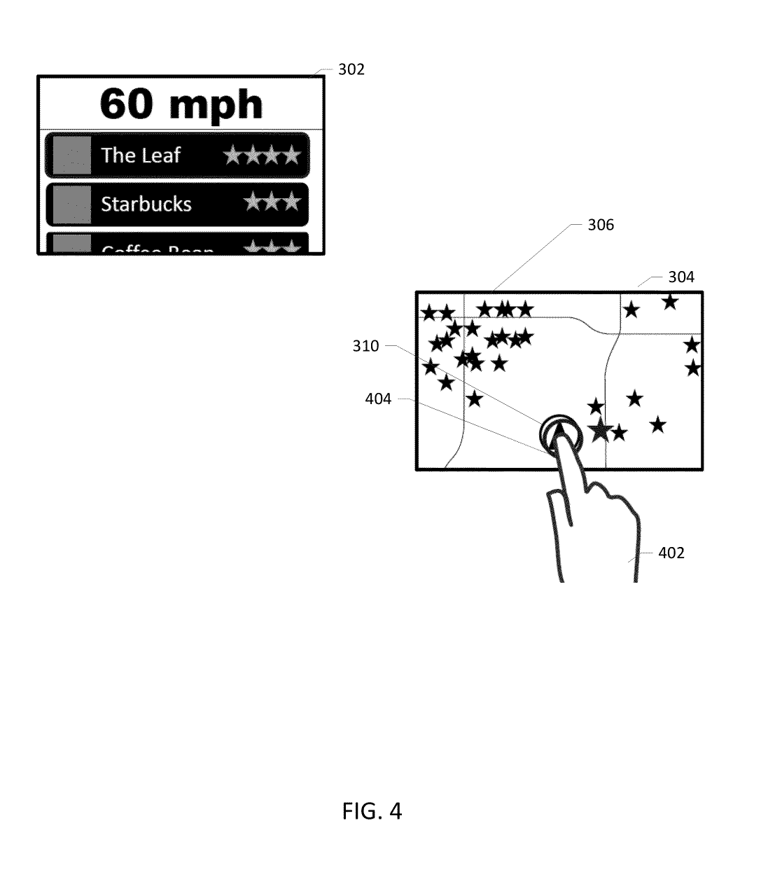

Referring now to FIG. 4, as an initial step to refining a default search area, a user 402 can press or select the default search area on the map display utilizing a tap gesture at the touchscreen display 304. To tap, the user 402 can make a quick up-and-down motion with a finger, lightly striking the touchscreen 304 at the location where the current vehicle location indicator 310 is displayed. In response to the tap, the system displays a user positionable indicator 404. In an aspect, the user positionable indicator 404 can be freely moved about the map display by the user 402 utilizing a drag gesture at the touchscreen display 304.

The user 402 is provided with a default search area on a map display and can engage the user positionable indicator 404 to alter or morph the default search area to include an area of interest rather than free-hand drawing a shape to establish points on the map within which to search. For a vehicle navigation system, the free-hand drawing of a shape to establish points on the map within which to search is not desirable as it may divert the user's attention. Free-hand drawing of shapes on the map display can contribute to a high distraction environment.

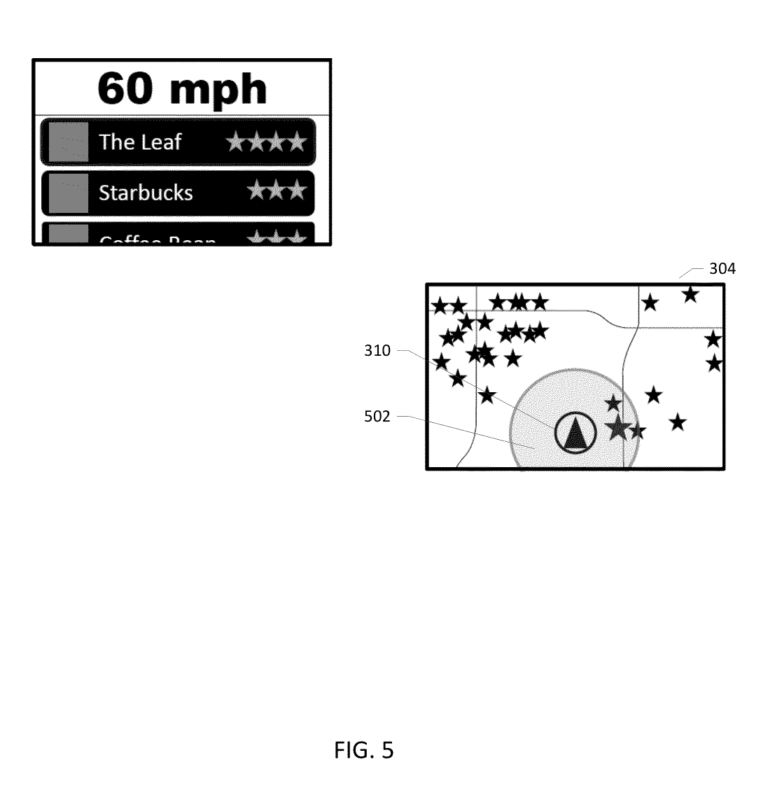

In response to a tap at the location where the current vehicle location indicator 310 is displayed on the touchscreen 304, the system 100 displays a substantially circular default search area 502 on the map display as shown in FIG. 5. Although the default search area 502 shown in FIG. 5 is substantially circular, the default search area 502 can include most any shape or form, or can be asymmetrical or irregularly shaped as noted above. The default search area 502, indicated on the map display on touchscreen 304, represents the geographical area within which a search for POI information is directed.

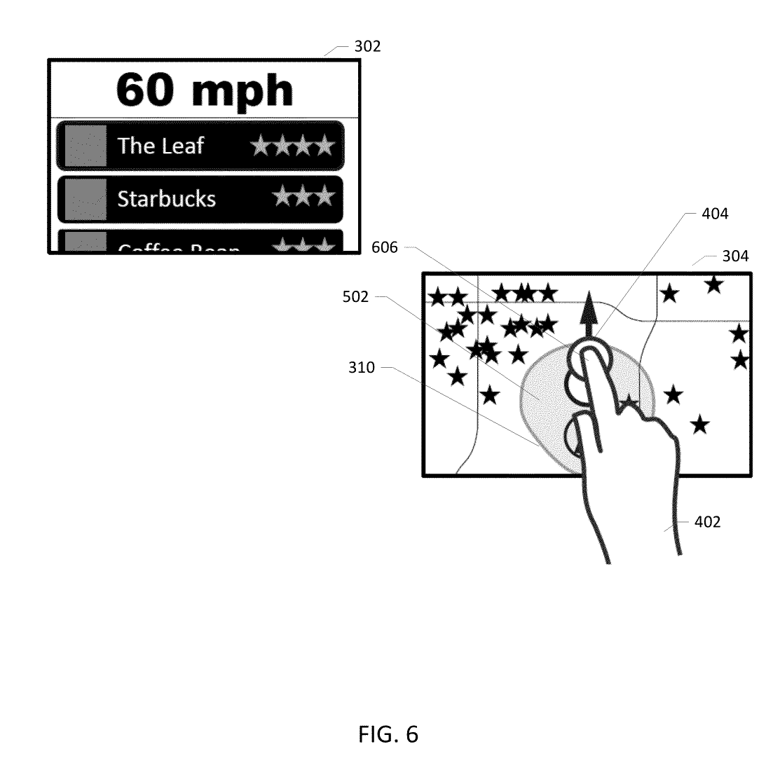

Referring now to FIG. 6, a user 402 can define a new search area by refining the default search area 502. The user 402 can refine the default search area 502 utilizing a gesture input 606 at the touchscreen display 304. As discussed above, a user positionable indicator 404 is displayed when the user 402 taps the touchscreen 304 at or near the location where the current vehicle location indicator 310 is displayed. The user can then drag the user positionable indicator 404 to the desired location on the map display by placing a finger on the touchscreen 304 and moving the user positionable indicator 404 to the desired location, while maintaining contact with the touchscreen 304.

As the user positionable indicator 404 is moved across the map display on touchscreen 304, the default search area stretches to include both the current vehicle location indicator 310 and the new location of the user positionable indicator 404. In an aspect, the user refined search area is based on a gesture input that commences, or originates, within a default search area on a map display and concludes at a user designated point on the map display.

The user may drag the user positionable indicator 404 in most any direction. The user positionable indicator 404 can be moved across the map display to the left, right, in front of or behind the vehicle or at an angle from the vehicle. To drag the user positionable indicator 404, the user 402 places a finger on the screen and moves the finger in the desired direction without lifting it from the screen. An optimal shape can be reached and the finger released.

The current vehicle location indicator 310 acts as an anchor and a user-refined search area is established that includes both the current vehicle location and a user designated point, e.g. the location of the user positionable indicator 404 when the user 402 has terminated the drag gesture 606 at the touchscreen 304. In an aspect, the gesture input 606 for refining the default search area originates at a point within a default or current search area and concludes at a user defined point on the map display. In accordance with an embodiment, a user defined point on the map display can be the point on the map display where the gesture input 606 concludes, e.g. the point on the map display where the user 402 breaks contact with the touchscreen display 304.

In accordance with an embodiment, the gesture input 606 for refining the default search area may be accomplished utilizing a three-dimensional gesture captured and recognized by a gesture capture and recognition component (not shown). In addition to touch sensing, the touchscreen display 304 may include areas that receive input from a user without requiring the user to touch the display area of the screen. In further embodiments, a gesture capture and recognition component can be separate from touchscreen display 304. The gesture capture and recognition component can receive input by recognizing gestures made by a user within a gesture capture area.

Gesture capture and gesture recognition can be accomplished utilizing known gesture capture and recognition systems and techniques including cameras, infrared illumination, three-dimensional stereoscopic sensors, real-time image processing, machine vision algorithms and the like.

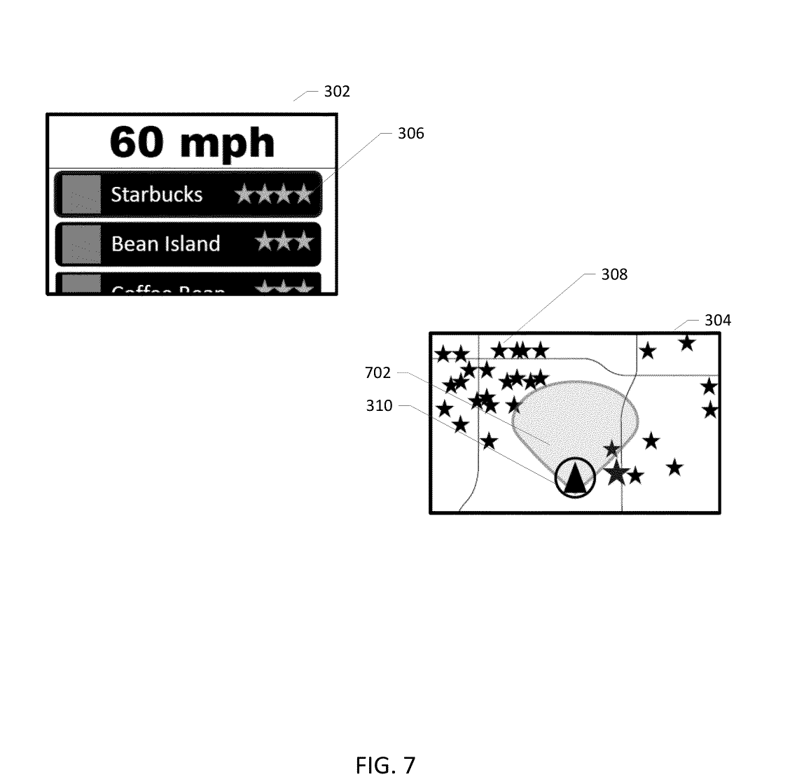

FIG. 7 illustrates information displays including meter display 302 and a touchscreen display 304 associated with navigation system 100 in accordance with aspects of the disclosure. A user-refined search area 702 has been established utilizing a gesture input 606, e.g. selecting and dragging the user positionable indicator as discussed in connection with FIG. 6.

As a result of establishing the user-refined search area 702, an updated POI list 306 and updated POI location indicators 308 are generated. The POI list 306 and POI location indicators 308 represents POIs that satisfy the search criteria as defined by the user, e.g. “coffee shops”, and are located within the user-refined search area 702. In the example illustrated in FIG. 7, the POI search criteria entered by the user is a search for “coffee shops” and the system displays coffee shops 306, 308 that are geographically located within the user-refined search area 702.

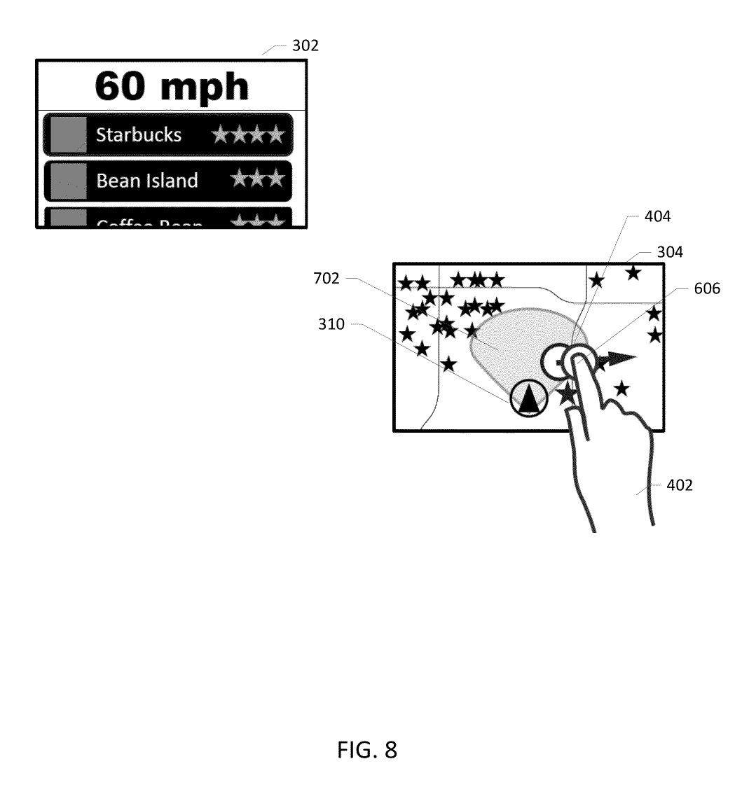

Turning to FIG. 8, a user 402 may alter or further refine a user-refined search area 702 by repeating the gesture input 606 steps of selecting and dragging the user positionable indicator 404 at the touchscreen 304. As shown in FIG. 8, a gesture input 606 can alter the search area to include destinations to the right of vehicle's current location 310. In an aspect, the user-refined search area 702 includes both the vehicle current location 310 and the area indicated by the user positionable indicator 404.

The system can be configured to maintain a search area of a pre-determined size. For example, the system 100 may be configured to maintain a search area encompassing five square kilometers. In an embodiment, as the user positionable indicator 404 is moved further from the vehicle current location 310, the user-refined search area becomes elongated, or narrower. Conversely, as the user positionable indicator 404 is moved closer to the vehicle current location 310, the user-refined search area can become geographically wider. In other embodiments, the user-refined search area can be configured to maintain a given width notwithstanding the distance between the user positionable indicator 404 and the vehicle current location 310.

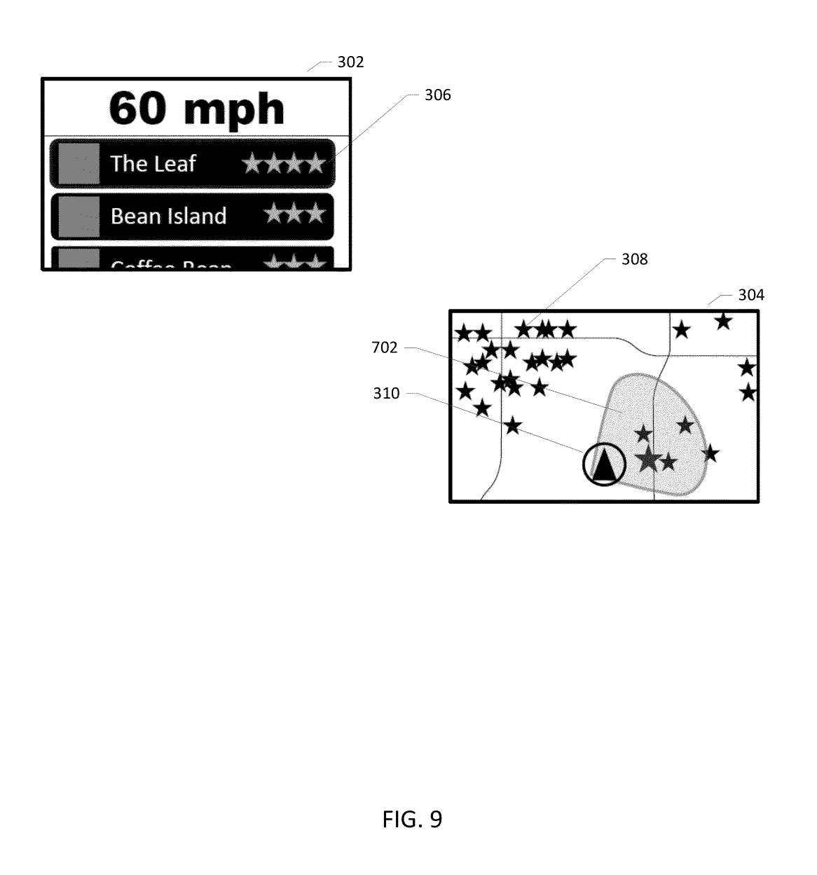

As shown in FIG. 9, as a result of the gesture input shown in FIG. 8, an updated POI list 306 and updated POI location indicators 308 are generated and displayed to the user. The user-refined search area 702 can be altered or further refined utilizing iterative gesture inputs. The POI list 306 and POI location indicators 308 represent POIs that satisfy the search criteria entered by the user and are located within the altered, or newly established, user-refined search area 702.

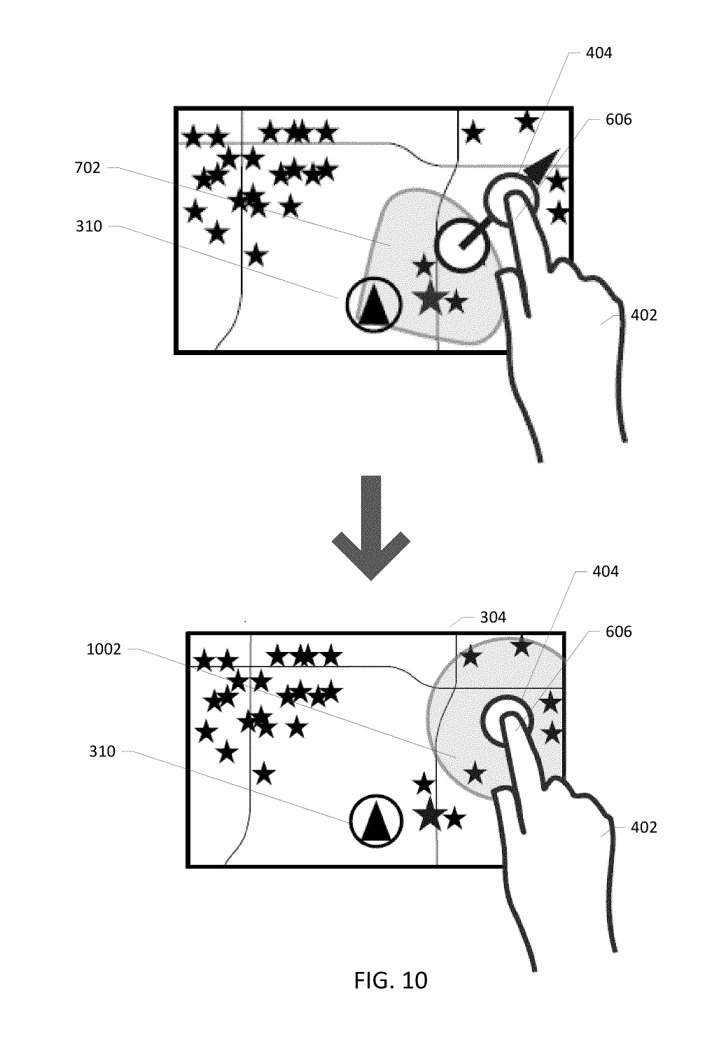

FIG. 10 illustrates navigation information displays associated with a navigation system in accordance with aspects of the disclosure. As discussed in detail above, a user 402 can refine a default search area, or a user-refined search area 702, utilizing a gesture input 606 at the touchscreen display 304. In accordance with an embodiment, when the user has moved the user positionable indicator 404 a pre-determined distance from the current vehicle location indicator 310, the search area 702 breaks away from current vehicle location indicator 310 and can be freely moved on the map display. In an aspect, the current vehicle location indicator 310 no longer acts as the search area anchor.

The freely movable search area 1002 is centered on the user positionable indicator 404 and can be positioned by the user 402 at a chosen location on the map display of touchscreen 304. The freely movable search area 1002 can retain the default search area size and shape.

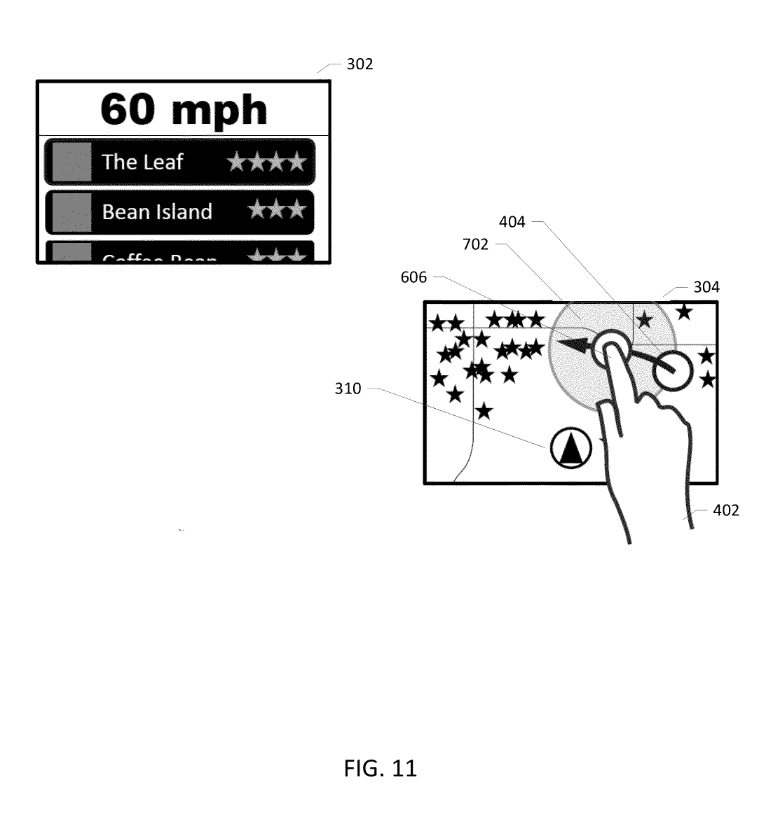

FIG. 11 illustrates navigation information displays associated with a navigation system in accordance with aspects of the disclosure. Once the user 402 has caused the search area to break free from the vehicle current location, as discussed in connection with FIG. 10, the search area may be moved in most any direction on the map display utilizing, for example, a drag gesture at the touchscreen display 304. In an aspect, the user-refined search area 702 does not include the vehicle current location 310.

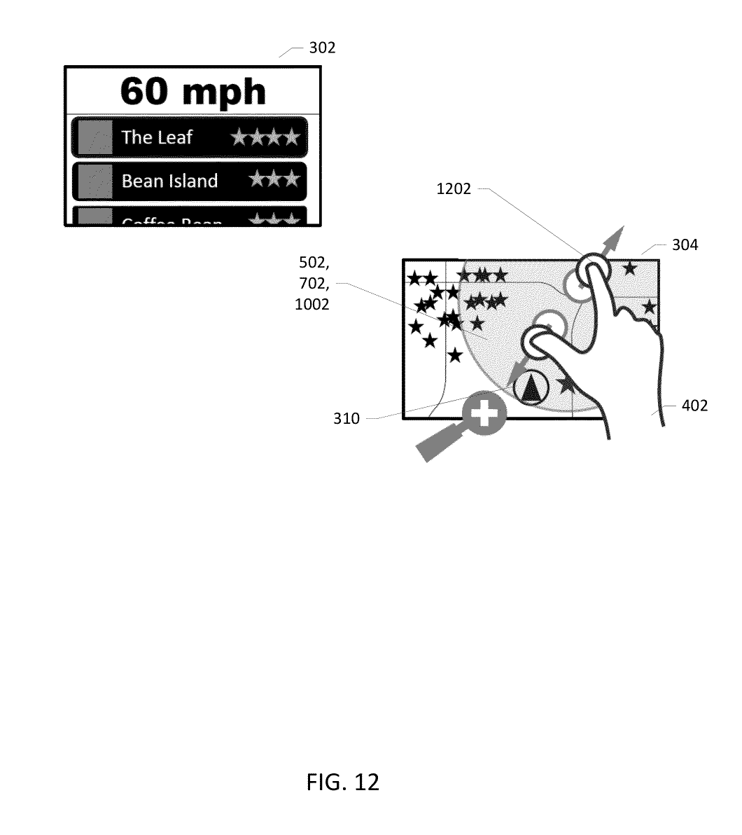

As shown in FIG. 12, a default search area 502, user-refined search area 702 or freely movable search area 1002 can be expanded or reduced utilizing a gesture 1202 at the map display of the touchscreen 304. For example, a two-finger gesture can be used to resize the search area. To expand the search area, the user 402 places the thumb and a finger (or two fingers) close together on the screen, within the displayed search area, and moves them apart without lifting them from the screen. To shrink or reduce the search area, the user 402 places the thumb and a finger (or two fingers) a small distance apart on the screen, within the displayed search area, and moves them toward each other without lifting them from the screen.

The pinch open and pinch closed gestures 1202 are intuitive motions that can easily be carried out by the user with a minimum of distraction. In aspects, the system can be configured to recognize other gestures as an indication to resize the default search area 502 and or a user-refined search area 702.

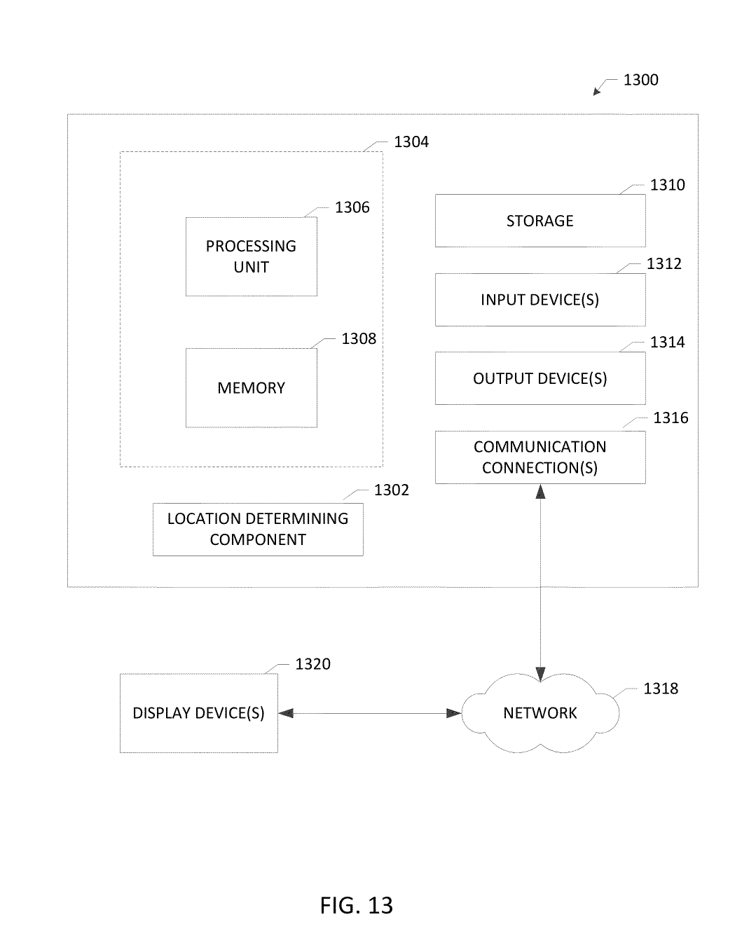

FIG. 13 and the following discussion provide a description of a suitable computing environment in which embodiments of one or more of the provisions set forth herein can be implemented. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 15 illustrates a navigation system 100 including a computing device 400 configured to implement one or more embodiments provided herein. In one configuration, the computing device can include at least one location determining component 1302, processing unit 1306 and memory 1308. Depending on the configuration and type of computing device, memory 1308 may be volatile, such as RAM, non-volatile, such as ROM, flash memory, etc., or a combination of the two. This configuration is illustrated in FIG. 13 by dashed line 1304.

Location determining component 1302 can include most any components for obtaining and providing navigation related information, including but not limited to, GPS antenna, GPS receiver for receiving signals from GPS satellites and detecting location, direction sensor for detecting the vehicle's direction, speed sensor for detecting travel distance, map database, point of interest database, other databases and database information and other associated hardware and software components.

Navigation system 1300 can include one or more input devices 1312 such as keyboard, mouse, pen, audio or voice input device, touch input device, infrared cameras, video input devices, gesture recognition module, or any other input device.

In embodiments, the system 1300 can include additional input devices 1312 to receive input from a user. User input devices 1312 can include, for example, a push button, touch pad, touchscreen, wheel, joystick, keyboard, mouse, keypad, or most any other such device or element whereby a user can input a command to the system. Input devices can include a microphone or other audio capture element that accepts voice or other audio commands. For example, a system might not include any buttons at all, but might be controlled only through a combination of gestures and audio commands, such that a user can control the system without having to be in physical contact with the system.

One or more output devices 1314 such as one or more displays 1320, including a vehicle center console display, video terminal, projection display, vehicle meter display, heads-up display, speakers, or most any other output device can be included in navigation system 1300. The one or more input devices 1312 and/or one or more output devices 1314 can be connected to navigation system 1300 via a wired connection, wireless connection, or any combination thereof. Navigation system 100 can also include one or more communication connections 1316 that can facilitate communications with one or more devices including display devices 1320 by means of a communications network 1318.

Communications network 1318 can be wired, wireless, or any combination thereof, and can include ad hoc networks, intranets, the Internet, or most any other communications network that can allow navigation system 100 to communicate with at least one other display device 1320.

Example display devices 1320 include, but are not limited to, a vehicle center console display, touchscreen display, video terminal, projection display, liquid crystal display, vehicle meter display, and heads-up display.

The operating environment of FIG. 13 is one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” or modules being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

In these or other embodiments, navigation system 100 can include additional features or functionality. For example, computing device 1300 of navigation system 100 can also include additional storage such as removable storage or non-removable storage, including, but not limited to, magnetic storage, optical storage, and the like. Such additional storage is illustrated in FIG. 13 by storage 1310. In certain embodiments, computer readable instructions to implement one or more embodiments provided herein are in storage 1310. Storage 1310 can also store other computer readable instructions to implement an operating system, an application program, and the like. Computer readable instructions can be loaded in memory 1308 for execution by processing unit 1306, for example.

In an aspect, the term “computer readable media” includes computer storage media. Computer storage media includes volatile and nonvolatile, removable and non-removable media implemented in any method or technology for storage of information such as computer readable instructions or other data. Memory 1308 and storage 1310 are examples of computer storage media. Computer storage media includes, but is not limited to, RAM, ROM, EEPROM, flash memory or other memory technology, CD-ROM, Digital Versatile Disks (DVDs) or other optical storage, or most any other medium which can be used to store the desired information and which can be accessed by the computing device 1300 of navigation system 100. Any such computer storage media can be part of navigation system 100.

In an embodiment, computer-readable medium includes processor-executable instructions configured to implement one or more embodiments of the techniques presented herein. Computer-readable data, such as binary data including a plurality of zero's and one's, in turn includes a set of computer instructions configured to operate according to one or more of the principles set forth herein. In one such embodiment, the processor-executable computer instructions is configured to perform a method, such as at least a portion of one or more of the methods described in connection with embodiments disclosed herein. In another embodiment, the processor-executable instructions are configured to implement a system, such as at least a portion of one or more of the systems described in connection with embodiments disclosed herein. Many such computer-readable media can be devised by those of ordinary skill in the art that are configured to operate in accordance with the techniques presented herein.

The term computer readable media includes most any communication media. Communication media typically embodies computer readable instructions or other data in a “modulated data signal” such as a carrier wave or other transport mechanism and includes any information delivery media.

What has been described above includes examples of the disclosure. It is, of course, not possible to describe every conceivable combination of components or methodologies for purposes of describing the disclosure, but one of ordinary skill in the art may recognize that many further combinations and permutations of the disclosure are possible. Accordingly, the disclosure is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer implemented method for providing navigation information, comprising:
utilizing one or more processors and memory storing one or more programs for execution by the one or more processors, the one or more programs including instructions for:
receiving a first user input;
providing a first set of navigation information in response to the first user input based on a default search area;
receiving a gesture input altering the default search area;
establishing a user-refined search area based on the gesture input; and
providing a second set of navigation information based on the user-refined search area.

2. The method for providing navigation information of claim 1, wherein providing a first set of navigation information includes displaying a default search area substantially surrounding a current location of a user on a map display.

3. The method for providing navigation information of claim 1, wherein receiving a gesture input altering the default search area includes receiving a gesture marking an area on the map display.

4. The method for providing navigation information of claim 3, wherein receiving a gesture marking an area on the map display comprises receiving a gesture input originating substantially at the default search area and concluding substantially at a user designated point on the map display.

5. The method for providing navigation information of claim 3, wherein receiving a gesture marking an area on the map display comprises receiving a touchscreen input.

6. The method for providing navigation information of claim 3, wherein receiving a gesture marking an area on the map display comprises receiving a three-dimensional gesture input.

7. The method for providing navigation information of claim 1, wherein establishing a user-refined search area based on the gesture user input comprises deriving a user-refined search area that includes at least a portion of the default search area.

8. The method for providing navigation information of claim 1, wherein establishing a user-refined search area based on the gesture input comprises deriving a user-refined search area that is exclusive of the default search area.

9. A car navigation system provided in a vehicle, the car navigation system comprising:
a display device;
an input component for receiving a user input;
a location determining component for determining a location of the vehicle;
a memory operable to store one or more modules; and
a processor operable to execute the one or more modules to determine navigation information and to provide navigation information for display on the display device based on the user input and the location of the vehicle;
a first set of navigation information based on a first user input and a default search area; and
a second set of navigation information including a user-refined search area, wherein the user-refined search area is based on a gesture input that commences at the default search area.

10. The car navigation system of claim 9, wherein the first set of navigation information includes a default search area substantially surrounding a current location of the vehicle on a map display.

11. The car navigation system of claim 10, wherein the gesture input includes a gesture marking an area on the map display.

12. The vehicle navigation system of claim 11, wherein the gesture marking an area on the map display comprises a gesture input concluding at a user designated point on the map display.

13. The vehicle navigation system of claim 12, wherein the input component comprises a touchscreen and the gesture marking an area on the map display comprises a touchscreen input.

14. The vehicle navigation system of claim 13, wherein the touchscreen input comprises a swiping, flicking, dragging, tapping, pressing, spreading or pinching gesture.

15. The vehicle navigation system of claim 9, wherein the input component comprises a three-dimensional input component and the gesture marking an area on the map display comprises a three-dimensional gesture input.

16. The vehicle navigation system of claim 9, wherein the user-refined search area includes at least a portion of the default search area.

17. The vehicle navigation system of claim 9, wherein the user-refined search area does not include the default search area.

18. A computer implemented method for providing navigation information, comprising:
utilizing one or more processors and memory storing one or more programs for execution by the one or more processors, the one or more programs including instructions for:
receiving a request for navigation information;
providing a point of interest list and map display in response to the request for navigation information, wherein the point of interest list and map display are based on a default search area;
receiving a gesture input marking an area of the map display;
establishing a user-refined search area based on the gesture input; and
updating the point of interest list and map display based on the user-refined search area.

19. The method for providing navigation information of claim 18, wherein receiving a gesture input marking an area of the map display comprises receiving a swiping, flicking, dragging, tapping, pressing, spreading or pinching gesture at a touchscreen display that alters the default search area and establishing a user-refined search area comprises deriving a user-refined search area that includes at least a portion of the default search area.

20. The method for providing navigation information of claim 18, wherein receiving a gesture input marking an area of the map display comprises receiving a gesture input that originates at a point within a current search area and concludes at a user designated point on the map display.
